(19) United States
(12) Patent Application Publication
(10) Pub. No.: US 2025/0151681 A1
(43) Pub. Date: May 15, 2025

(54) HYDROPONIC PLANTING UNIT

(71) Applicant: KANAYA AGRICULTURAL TECHNOLOGY CO., LIMITED, Hong Kong (HK)

(72) Inventor: Ho KING YIN EDWIN, Hong Kong (HK)

(21) Appl. No.: 18/934,761

(22) Filed: Nov. 1, 2024

(30) Foreign Application Priority Data
Nov. 14, 2023 (CN) 2023230623576

(51) Int. Cl. A01G 31/02

(52) U.S. Cl. CPC A01G 31/02

(57) ABSTRACT

A hydroponic planting unit, comprises a panel with a predetermined shape, the planting compartment for growing plants is provided in the panel, and a plurality of hydroponic planting units are spliced together to from an integrated and light-blocking panel plane through the panels in conjunction with each other. The hydroponic planting unit can be spliced or moved according to the different growth stages of plants, and is very convenient to adjust.

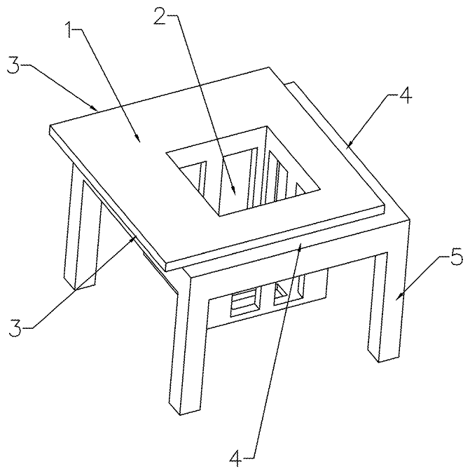

### FIELD OF THE INVENTION

The present invention relates to an accessory used in hydroponic planting, particularly a planting unit for accommodating hydroponically grown plants.

### BACKGROUND OF THE INVENTION

Hydroponics is a new trend in indoor or urban agriculture, utilizing only water and medium to grow plants. The concept of agriculture dates back centuries when Babylon used hanging gardens to grow plants. Dramatic floating gardens may be seen in the middle, adding another aesthetic to its iconic architecture. The system is considered the future of agriculture. Hydroponics has some advantages and disadvantages. Hydroponic systems are an efficient method of growing crops in urban areas in extreme climatic conditions. Hydroponics has countless benefits over traditional farming systems. The technique reduces the use of chemicals, increases the yield at the nutrient level, and if suitable for growing organic food. According to a report by research and markets, vertical farming is expected to grow by $3 billion by 2024. From a business perspective, this is enough to bring the economic aspects of hydroponics into the discussion.

If the advantages/benefits of Hydroponics is thought that adapting to hydroponics requires only a soilless environment, tit is fair to consider the many other advantages of hydroponics. Hydroponic plants usually grow faster and better under systems that are controlled through machinery. The following factors are why hydroponics is the future of agriculture.

Growing plants on land requires more water and soil nutrients, most of which are wasted in traditional agricultural practices. According to research, over 70% of the world's freshwater is used for agriculture. In contrast, hydroponic systems are more efficient in water using because plants are grown in climate-controlled environments, only use precise amounts of water in need. This practice consumes up to ten times less water compared to traditional agriculture.

Higher yields in hydroponics are less dependent on climatic conditions, which makes hydroponic agriculture minimally affected by drought and water scarcity. This cultivation system is particularly suited for regions with extreme weather, thereby enhancing crop production. The more controllable nature of hydroponic systems allows farmers to grow seasonal crops year-round to meet population demands. Moreover, the growth density of crops grown in hydroponic systems is 16 times higher than that of vegetables grown in soil.

Hydroponics occupies less space. Hydroponic systems emphasize growing fruits and vegetables suitable for human consumption. Hydroponic plants grow in small spaces and do not require land except for proper temperature, light and balanced water conditions. Hydroponics can also be grown in space.

Pest control is a significant advantage of hydroponics. The absence of soil means that weeds do not grow around the crops, reducing farmers' reliance on herbicides and fertilizers while providing hydroponic plants with the appropriate nutrients. When the system operates under controlled conditions, such as specific temperatures and humidity levels suited to the plants, it becomes less hospitable for insects and pests. Additionally, since soil is not used, the environment is more easily managed to prevent unwanted intruders.

Hydroponic planting cultivation systems generally require the use of planting units for fixing plants and placing them in the hydroponic planting water supply system, which on the one hand facilitates the planting of plant seedlings, and on the other hand facilitates the provision of sufficient growing space for plants by adjusting the spacing between planting units in accordance with the growth of the plants. Existing planting units are generally designed with round planting baskets, and there is generally no connection structure between the baskets, so they need to be placed in the planting panel with fixed spacing holes for fixing. When the plant is in the growth stage of the seedling is relatively small, the planting spacing can be reduced to save the planting area, even so, the traditional design of the planting basket and planting panel is difficult to avoid the light used for the growth of the plant irradiated to the planting panel at the bottom of the planting panel, which will lead to the breeding of moss and affect the development of the roots of the plant. Moreover, when the plants grow up, it is inconvenient to pull out the basket from the opening of the panel and adjust the spacing between the plants.

### SUMMARY OF THE INVENTION

Aiming at the shortcomings of the above prior art, the present invention provides a novel hydroponic planting unit, which can connect the hydroponic planting unit to form an integrated panel plate by splicing panels, and at the same time, it can conveniently adjust the planting spacing between plants according to the growth situation of plants.

The present invention is realized by the following technical solutions:

A hydroponic planting unit, comprising a panel with a predetermined shape, a planting compartment for growing plants is provided in the panel, and a plurality of hydroponic planting units are spliced together to from an integrated and light-blocking panel plate through the panels in conjunction with each other.

Further, the panel is a parallelogram or a regular hexagon, an opposite or adjacent edges of the panel provided with a corresponding number of convex edges or steps for placing the convex edges; the convex edges of one panel places on the step of another panel to splice the adjacent panels.

Further, the bottom of the panel is equipped with support legs, the length of the support legs is greater than the depth of the planting compartment.

Further, the wall of the planting compartment is provided with multiple hollow holes for facilitating the growth of plant roots.

The beneficial effects of the embodiment of the present invention are: when the plants are in the growth stage of the seeding, the hydroponic planting units can be spliced together through the panels to form an integrated panel plate to block light, thereby increasing planting density. This integrated plate prevents light used for planting from reaching the bottom of the panel, which helps inhibit moss growth and ensures healthy root development for the seedlings. When the plants grow and require sufficient space, the hydroponic planting units can be easily moved relative to maintain appropriate spacing. This adjustment is very convenient and does not require lifting the entire plant to prevent damaging or breaking the roots. So the design may not harm plant roots, while the hydroponic planting unit module only need to be moved, minimizing the risk of root damage.

### BRIEF DESCRIPTION OF THE DRAWINGS

The present invention will be further described below with the accompanying drawings:

The FIGURE is a perspective view of the present invention.

### DESCRIPTION OF THE EMBODIMENTS

Referring to the Figure, the hydroponic planting unit comprises a panel 1 with a predetermined shape. the planting compartment 2 for growing plants is provided in the panel 1. The plurality of hydroponic planting units are spliced together to form an integrated and light-blocking panel plate through the panels 1 in conjunction with each other. when the plants are in the growth stage of the seeding, the hydroponic planting units can be spliced together through the panels a to form an integrated panel plate to block light, thereby increasing planting density. This integrated plate prevents light used for planting from reaching the bottom of the panel 1, which helps inhibit moss growth and ensures healthy root development for the seedlings. When the plants grow and require sufficient space, the hydroponic planting units can be easily moved relative to maintain appropriate spacing. This adjustment is very convenient and does not require lifting the entire plant to prevent damaging or breaking the roots. So the design may not harm plant roots, while the hydroponic planting unit module only need to be moved, minimizing the risk of root damage.

To facilitate the panels of the hydroponic planting units being spliced together to form an integrated panel plate, the panel 1 is designed as a parallelogram or a regular hexagon for splicing the adjacent panels 1, the opposite or adjacent edges of panel 1 are provided with a corresponding number of convex edges 3 or steps 4 for placing the convex edges 3. While splicing, the convex edge 3 of one panel 1 can simply place on the step 4 of another panel 1, and it is not necessary to using a fixed splicing structure. This design allows for quick and convenient assembly while ensuring that planting compartment 2 maintain appropriate and uniform spacing. Additionally, when needs to adjust the spacing of the hydroponic planting units, it is very convenient to simply move them without any need for disassembly.

To facilitate the placement of the hydroponic planting unit in the reservoir and ensure that the plant roots maintain sufficient growth space from the bottom of the reservoir, support legs 5 are provided on the bottom of panel 1. The length of support legs 5 is greater than the depth of the planting compartment 2. The specific length of the support legs can be adjusted according to the growth requirements of different plant root systems.

Additionally, the walls of planting compartment 2 are equipped with multiple hollow holes to allow plant roots passing through the holes when growth and to absorb nutrients from the reservoir.

1. A hydroponic planting unit, comprising
a panel with a predetermined shape, a planting compartment for growing plants is provided in the panel, and a plurality of hydroponic planting units are spliced together to from an integrated and light-blocking panel plate through the panels in conjunction with each other.

2. The hydroponic planting unit of claim 1, wherein the panel is a parallelogram or a regular hexagon, an opposite or adjacent edges of the panel provided with a corresponding number of convex edges or steps for placing the convex edges; the convex edges of one panel places on the step of another panel to splice the adjacent panels.

3. The hydroponic planting unit of claim 1, wherein the bottom of the panel is equipped with support legs, the length of the support legs is greater than the depth of the planting compartment.

4. The hydroponic planting unit of claim 1, wherein the wall of the planting compartment is provided with multiple hollow holes for facilitating the growth of plant roots.
